(19) United States
(12) Patent Application Publication
(10) Pub. No.: US 2015/0229256 A1
(43) Pub. Date: Aug. 13, 2015

(54) METHOD AND DEVICE TO REGULATE THE ELECTRIC MOTOR OF A HANDHELD POWER TOOL

(71) Applicant: Hilti Aktiengesellschaft, Schaan (LI)

(72) Inventors: Markus Forstner, Landsberg (DE); Manfred Jakob, Kaufering (DE)

(21) Appl. No.: 14/423,018

(22) PCT Filed: Aug. 21, 2013
(86) PCT No.: PCT/EP2013/067357

§ 371 Date: Feb. 20, 2015

(30) Foreign Application Priority Data
Aug. 23, 2012 (DE) 10 2012 214 975.9

(51) Int. Cl. H02P 7/24; H02K 7/14

(52) U.S. Cl. CPC H02P 7/245; H02K 7/145; H02P 2007/0088

(57) ABSTRACT

A method to regulate the electric motor of a handheld power tool, the method encompassing the following steps: prescribing a target speed for the electric motor, varying the prescribed target speed—each time after a certain period of time has lapsed—by a value within a certain variation range in order to supply a varied target speed, and regulating an actual speed of the electric motor to the supplied varied target speed.

The present invention relates to a method and to a device to regulate the electric motor of a handheld power tool. The invention also relates to a control unit for a handheld power tool having such a device as well as to such a handheld power tool, especially an electric handheld power tool such as, for instance, an electric screwdriver or a handheld power drill.

### BACKGROUND

The electric motor of the handheld power tool is normally regulated to a target speed by means of a speed regulator.

However, modern speed regulators sometimes work so precisely that resonance effects can cause the commutators of mechanically commutated motors to run out-of-round. This can excessively increase the carbon wear of the mechanically commutated motors. This increase in the carbon wear reduces the service life of the mechanically commutated motor of the handheld power tool.

### SUMMARY OF THE INVENTION

It is an object of the present invention to improve the regulation of the electric motor of a handheld power tool.

The present invention provides a method to regulate the electric motor of a handheld power tool, said method encompassing the following steps: prescribing a target speed for the electric motor, varying the prescribed target speed—each time after a certain period of time has lapsed—by a value within a certain variation range in order to supply a varied target speed, and regulating an actual speed of the electric motor to the supplied varied target speed.

Owing to the variation of the target speed, the actual speed of the electric motor can be systematically varied, especially it can be systematically varied by a certain operating point. The operating point is determined in that a user actuates an actuatable switch of the handheld power tool. Thanks to the systematic variation of the actual speed of the electric motor, resonance effects on the commutators of mechanically commutated electric motors are prevented. In this manner, it is prevented or avoided that the commutators of the mechanically commutated electric motors can run out-of-round, and consequently, excessive carbon wear is prevented. This translates into an increase in the service life of the handheld power tool.

In one embodiment, the target speed is prescribed in that a user actuates an actuatable switch of the handheld power tool.

In this manner, the operator or user of the handheld power tool prescribes the target speed which, according to the invention, is varied by a (small) value within the determined variation range.

In another embodiment, the method comprises the following steps: specifying the period of time for the variation of the prescribed target speed, and varying the prescribed target speed each time after the specified period of time has lapsed.

According to this embodiment, the period of time after which the prescribed target speed is varied can be specified ahead of time. The specified period of time can be stored in memory unit of the handheld power tool.

In another embodiment, the prescribed target speed is varied each time after a determinable period of time has lapsed, whereby the period of time is determined each time by means of a random generator.

As an alternative to a specified period of time, the period of time can also be determined each time by means of the random generator. This yields a sequence of varying periods of time so that the prevention of the resonance effect on the commutators of a mechanically commuted motor is further improved.

In another embodiment, the method comprises the following steps: specifying the value for the variation of the target speed, and, each time after a certain period of time has lapsed, varying the prescribed target speed by the specified value in order to supply the varied target speed.

The value or variation value of the target speed can be specified ahead of time, that is to say, before the handheld power tool is used for the first time. This specified value can be stored in the memory unit of the handheld power tool.

In another embodiment, the prescribed target speed is incremented by the specified value each time after the (2n)^{th} period of time has lapsed, and decremented by the specified value each time after the (2n+1)^{th} period of time has lapsed (n∈□). In this manner, the prescribed target speed is alternatingly increased somewhat and then decreased again. This constitutes a simple embodiment of the variation of the target speed. The mean speed remains constant. The period of time is more than 10 times the duration of one revolution of the rotor.

In another embodiment, each time after a certain period of time has lapsed, the prescribed target speed is varied by an appertaining determinable value in order to supply the varied target speed, whereby the appertaining value is determined by means of a random generator.

This embodiment constitutes an alternative for the use of specified values for the variation of the target speed. As a result of the use of values that can be determined by a random generator as is being put forward here, the resonance effect on the commutators of a mechanically commutated motor are further reduced.

In another embodiment, each time after the period of time has lapsed, the prescribed target speed is varied by at least 50 rpm in order to supply the varied target speed. The value of 50 rpm constitutes a minimum value for the variation of the target speed.

In another embodiment, the variation range is determined by a 5%-deviation from the prescribed target speed, preferably by a 3%-deviation from the prescribed target speed, especially preferably by a 2%-deviation from the prescribed target speed.

In another embodiment, a phase angle is used for a phase-angle control of the electric motor as the controlled variable for the regulation to the actual speed.

In another embodiment, the electric motor is a brushed motor.

A device to regulate the electric motor of a handheld power tool is likewise being put forward here. The device has an input means, a variation means and a regulation means. The input means is configured to prescribe a target speed for the electric motor. The variation means is configured to vary the prescribed target speed by a value within a certain variation range each time after a certain period of time has lapsed, in order to supply a varied target speed. The regulation means is configured to regulate the actual speed of the electric motor to the supplied varied target speed.

Each one of the means, that is to say, the input means, the variation means and the regulation means, can be implemented in the form of hardware and/or software. If implemented in the form of hardware, the means in question can be configured as a device or part of a device, for example, as a computer or as a microprocessor. If implemented in the form of software, the means in question can be configured as a computer program product, as a function, as a routine, as part of a program code or as an executable object.

A control unit for a handheld power tool is likewise being put forward here, whereby the above-mentioned device to regulate the electric motor of the handheld power tool is integrated into the control unit. Therefore, the device is part of the control unit of the handheld power tool, also referred to as a switch.

A handheld power tool having such a device is likewise being put forward here. The handheld power tool is especially an electric handheld power tool such as, for instance, an electric screwdriver, a handheld power drill, a chisel hammer, a combination hammer, a battery-powered screwdriver, a circular saw or a saber saw.

### BRIEF DESCRIPTION OF THE DRAWINGS

The description below explains the invention on the basis of embodiments and figures given by way of examples. The figures show the following:

FIG. 1: a handheld power tool;

FIG. 2: a schematic flowchart of a method to regulate the electric motor of a handheld power tool;

FIG. 3: a schematic block diagram of an embodiment of a device to regulate the electric motor of a handheld power tool; and.

### DETAILED DESCRIPTION

Unless otherwise indicated, identical or functionally equivalent elements are designated by the same reference numerals in the figures.

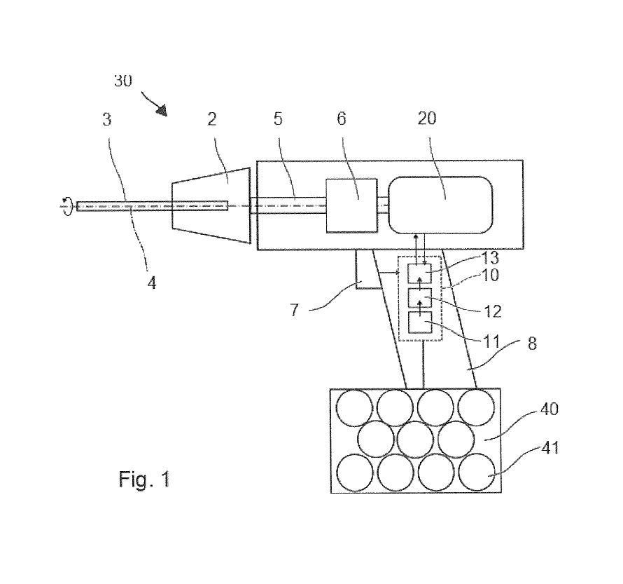

FIG. 1 shows by way of an example a handheld power tool 30, for instance, an electric screwdriver. The handheld power tool has a tool socket 2 into which a tool 3 can be inserted or attached. The tools are, for example, a screw bit, a drill bit, a grinding disk or a saw blade. An electric motor 20 drives the tool socket 2, here for instance, so as to rotate around a working axis 4. A powertrain situated between the tool socket 2 and the electric motor 20 can comprise a spindle 5, a gear 6 and additional components, e.g. a torque coupler, an eccentric wheel.

A user starts the handheld power tool 30 by actuating a switch 7. The switch 7 is preferably located on a handle 8 by means of which the user can hold and guide the handheld power tool 30. In response to the actuation, a control unit 10 supplies power to the electric motor 20. An example of a source of power for the handheld power tool 30 is a battery pack 40 containing several secondary battery cells 41.

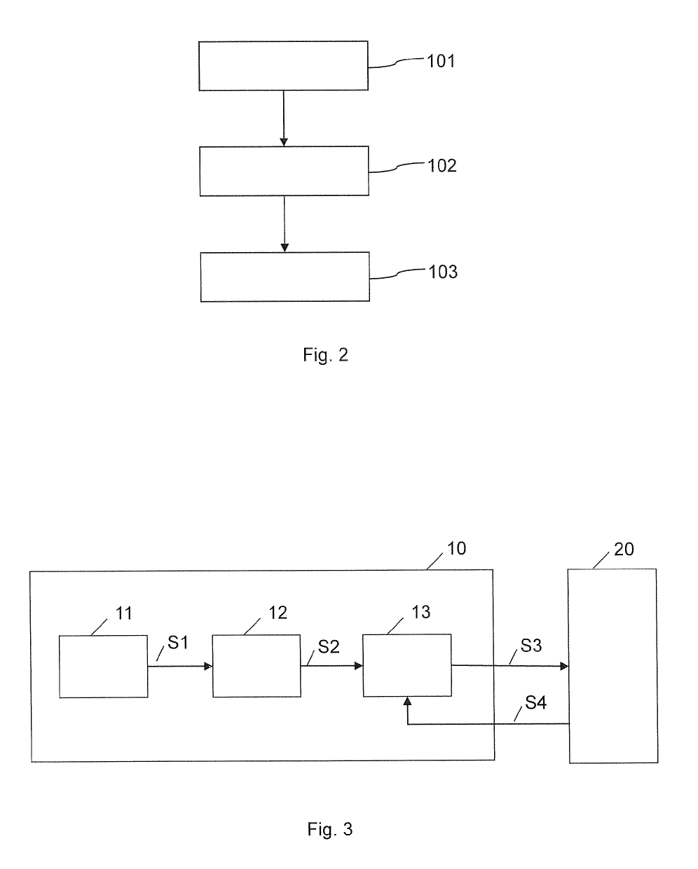

FIG. 2 shows a schematic flowchart of a method to regulate the electric motor 20 of a power tool 30 (also see FIG. 3).

In step 101, a target speed Si is prescribed for the electric motor 20.

In this context, the target speed Si is prescribed, for instance, in response to the actuation of an actuatable switch 7 of the handheld power tool 30 by a user.

In step 102, each time after a certain period of time has lapsed, the prescribed target speed S1 is varied by a value within a certain variation range in order to supply a varied target speed S2.

For example, the period of time for the variation of the prescribed target speed Si is specified and the prescribed target speed Si is varied each time after this specified period of time has lapsed. The specified period of time can especially be specified before the handheld power tool 30 is used for the first time and it can be stored in the memory unit of the handheld power tool 30.

As an alternative to this, the prescribed target speed Si can be varied each time after a determinable period of time has lapsed. Here, the determinable period of time can be determined each time by means of a random generator. In this manner, the sequence of the periods of time consists of virtually random periods of time of different durations.

Moreover, the value for the variation of the target speed S1 can be specified, that is to say, determined in advance. Then, each time after a certain period of time has lapsed, the prescribed target speed S1 can be varied by the specified value in order to supply the varied target speed S2. In this context, for example, a prescribed target speed S1 is incremented by the specified value each time after the (2n)^{th} period of time has lapsed, and decremented by the specified value each time after the (2n+1)^{th} period of time has lapsed (n∈□). As an alternative to the use of specified values, it is also possible to employ determinable values that are determined by means of a random generator. Here, the random generator can determine the determinable value each time after a certain period of time has lapsed, for instance, after a specified period of time has lapsed or after a period of time that can be determined by means of a random generator has lapsed.

All in all, each time after the period of time has lapsed, the prescribed target speed S1 is varied by at least 50 rpm in order to supply the varied target speed S2. The variation range within which the value of the target speed S2 is varied is preferably determined by a 5%-deviation from the prescribed target speed S1.

In step 103, the actual speed of the electric motor is regulated to the supplied varied target speed. A phase angle is preferably used for a phase-angle control of the electric motor 20 as the controlled variable S3 to regulate the varied target speed S2 to the actual speed S4.

The proposed method can be employed, for example, with handheld power tools having carbon brushed motors.

FIG. 3 shows a schematic block diagram of an embodiment of a device 10 to regulate the electric motor 20 of a handheld power tool 30.

The device 10 of FIG. 2 has an input means 11, a variation means 12 and a regulation means 13. The input means 11 is configured to prescribe a target speed S1 for the electric motor 20. The variation means 12 is configured to vary or change the prescribed target speed S1 by a value within a certain variation range each time after a period of time has lapsed, in order to supply a varied target speed S2. The regulation means 13 is configured to regulate the actual speed S4 of the electric motor 20 to the supplied varied target speed S2. For this purpose, the regulation means 13 controls the electric motor 20 by means of a controlled variable S3. The controlled variable S3 is, for instance, a phase angle for a phase-angle control of the electric motor 20.

What is claimed is:

1-10. (canceled)

11. A method to regulate an electric motor of a handheld power tool, the method comprising:
prescribing a target speed for the electric motor;
varying the prescribed target speed each time after a certain period of time has lapsed by a value within a certain variation range in order to supply a varied target speed; and
regulating an actual speed of the electric motor to the supplied varied target speed.

12. The method as recited in claim 11 wherein the target speed is prescribed by a user actuating an actuatable switch of the handheld power tool.

13. The method as recited in claim 11 further comprising the following steps:
specifying the certain period of time for the variation of the prescribed target speed and varying the prescribed target speed each time after the specified certain period of time has lapsed.

14. The method as recited in claim 11 wherein the prescribed target speed is varied each time after the certain period of time has lapsed, whereby the certain period of time is determined each time by a random generator.

15. The method as recited in claim 11 further comprising the following steps:
specifying the value for the variation of the target speed, and, each time after the certain period of time has lapsed, varying the prescribed target speed by the specified value in order to supply the varied target speed.

16. The method as recited in claim 15 wherein the prescribed target speed is incremented by the specified value each time after the (2n)^{th} certain period of time has lapsed, and decremented by the specified value each time after the (2n+1)^{th} certain period of time has lapsed, wherein n∈N.

17. The method as recited in claim 11 wherein, each time after the certain period of time has lapsed, the prescribed target speed is varied by an appertaining determinable value in order to supply the varied target speed, the appertaining value being determined by a random generator.

18. A device to regulate the electric motor of a handheld power tool, the device comprising:
an input to prescribe a target speed for the electric motor;
a varier to vary the prescribed target speed by a value within a certain variation range each time after a period of time has lapsed in order to supply a varied target speed; and
a regulator to regulate an actual speed of the electric motor to the supplied varied target speed.

19. A control unit for a handheld power tool comprising the device as recited in claim 18, the device being integrated into the control unit.

20. A handheld power tool comprising the device as recited in claim 18.
